(19) United States
(12) Patent Application Publication
(10) Pub. No.: US 2006/0020448 A1
(43) Pub. Date: Jan. 26, 2006

(54) Method and apparatus for capitalizing text using maximum entropy

(75) Inventors: Ciprian I. Chelba, Seattle, WA (US); Alejandro Acero, Bellevue, WA (US)

Correspondence Address: WESTMAN CHAMPLIN (MICROSOFT CORPORATION), SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/977,870

(22) Filed: Oct. 29, 2004

Related U.S. Application Data
(60) Provisional application No. 60/590,041, filed on Jul. 21, 2004.

(51) Int. Cl. G06F 17/21

(52) U.S. Cl. 704/10

(57) ABSTRACT

A method and apparatus are provided for selecting a form of capitalization for a text by determining a probability of a capitalization form for a word using a weighted sum of features. The features are based on the capitalization form and a context for the word.

The present application claims priority from U.S. provisional application 60/590,041 filed on Jul. 21, 2004.

### BACKGROUND OF THE INVENTION

The present invention relates to automatic capitalization. In particular, the present invention relates to capitalizing text using a model.

Automatic capitalization involves identifying the capitalization of words in a sentence. There are four different ways in which a word can generally be capitalized. The word may be in all lower case letters, all upper case letters, have just the first letter of the word in upper case and the rest of the letters in lower case, or have mixed case where some of the letters in the word are upper case and some are lower case.

One system of the prior art for identifying capitalization of words in sentences used a unigram model and a special capitalization rule. The unigram model is trained to identify the most common capitalization form for each word in a training database. The special rule capitalizes the first letter of any word that appears as the first word in a sentence and is used in place of the unigram-predicted form of capitalization for the word.

In a second capitalization system, a special language model is trained to provide probabilities of capitalization forms for words. To train the language model, each word in a training text is first tagged with its capitalization form. Each word and its tag are then combined to form a pair. Counts of the number of times sequences of pairs are found in the training text are then determined and are used to generate a probability for each sequence of pairs. The probability generated by the language model is a joint probability for the word and the tag and is not a conditional probability that conditions the tag on the word.

Another approach to capitalization is a rule-based tagger, which uses a collection of rules in order to determine capitalization.

These prior models for capitalization have not been ideal. As such, a new model of capitalization is needed.

### SUMMARY OF THE INVENTION

A method and apparatus are provided for selecting a form of capitalization for a text by determining a probability of a capitalization form for a word using a weighted sum of features. The features are based on the capitalization form and a context for the word.

### BRIEF DESCRIPTION OF THE DRAWINGS

FIG. 1 is a block diagram of one computing environment in which the present invention may be practiced.

FIG. 2 is a block diagram of an alternative computing environment in which the present invention may be practiced.

FIG. 3 is a flow diagram of a method of identifying capitalization for words in a string of text.

FIG. 4 is a flow diagram of a method for adapting a maximum entropy model under one embodiment of the present invention.

FIG. 5 is a block diagram of elements used in adapting a maximum entropy model under one embodiment of the present invention.

### DETAILED DESCRIPTION OF ILLUSTRATIVE EMBODIMENTS

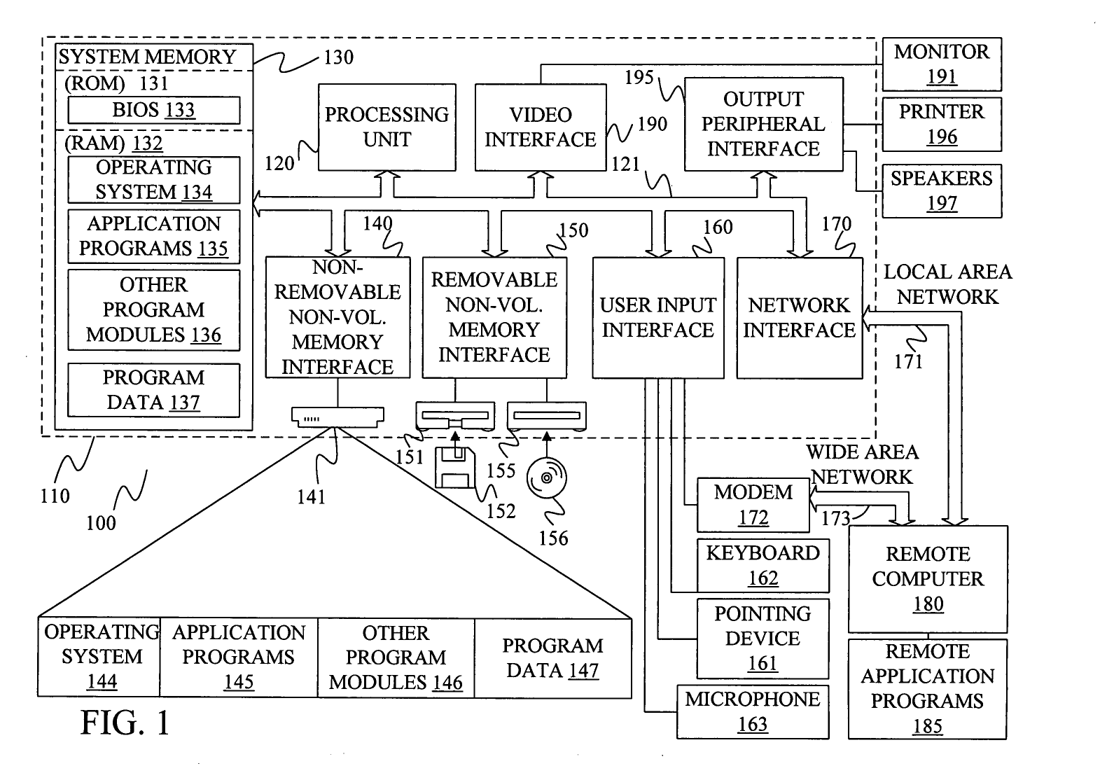

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

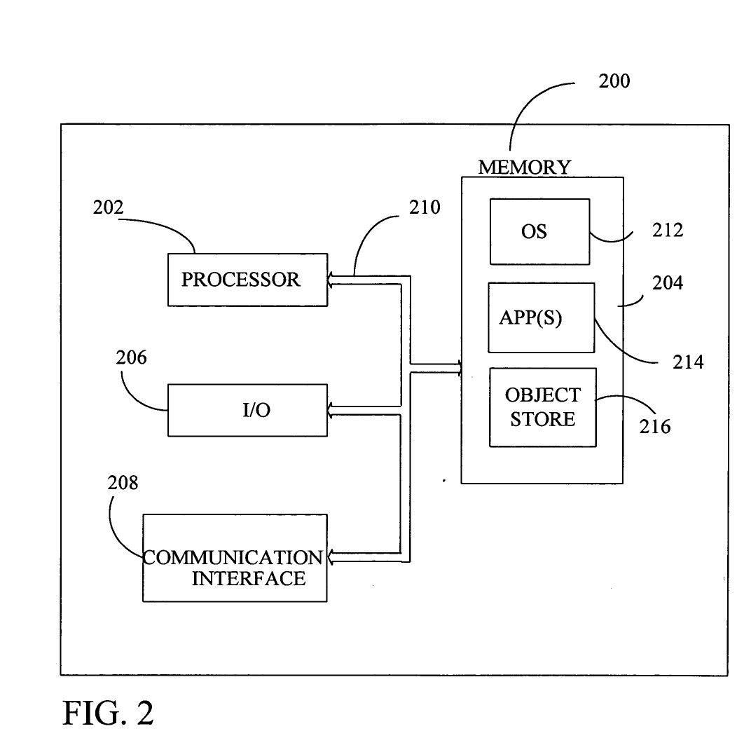

FIG. 2 is a block diagram of a mobile device 200, which is an exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200 within the scope of the present invention.

The present invention approaches the problem of identifying capitalization for a sentence as a sequence labeling problem in which a sequence of words is assigned a sequence of capitalization tags that indicate the type or form of capitalization to be applied to the words. Under one embodiment, the possible capitalization tags include:
LOC : lowercase
CAP : capitalized
MXC : mixed case; no further guess is made as to the capitalization of such words. A possibility is to use the most frequent one encountered in the training data.
AUC : all upper case
PNC : punctuation.

Based on this approach, one embodiment of the present invention constructs a Markov Model that assigns a probability p(T|W) to any possible tag sequence T=t₁ . . . =T₁″ for a given word sequence W=w₁ . . . wₙ. Under one embodiment, this probability is determined as:

$$P ( T \vert W ) = {\prod }_{i - 1}^{n} P ( {t}_{i} \vert {\underline{x}}_{i} ( W , {T}_{1}^{i - 1} ) ) \qquad EQ . 1$$

where tᵢ is the tag corresponding to word i and xᵢ(W,T₁ⁱ⁻¹) is the conditioning or context information at position i in the word sequence on which the probability model is built.

Under one embodiment, the context information is information that can be determined from the preceding word, the current word, and the next word in the word sequence as well as the preceding two capitalization tags. The information provided by these values includes not only the words and tags themselves, but portions of each of the words, and bigrams and trigrams formed from the words and bigrams formed from the tags.

Under one embodiment of the invention, the probability P(Tᵢ|xᵢ(W,T₁ⁱ⁻¹) is modeled using a Maximum Entropy model. This model uses features, which are indicator functions of the type:

$$f ( y , \underline{x} ) = \{ \begin{matrix}1 , if y = feature ' s tag & and \underline{x} = feature ' s context \\ 0 , & otherwise\end{matrix} \qquad EQ . 2$$

where y is used in place of tᵢ, and x represents the context information xᵢ(W,T₁ⁱ⁻¹). Although the features are shown as having values of 0 or 1, in other embodiments, the feature values may be any real values.

Assuming a set of features F whose cardinality is F the probability assignment is made according to:

$$\begin{matrix}{p}_{Λ} ( y \vert \underline{x} ) = {Z}^{- 1} ( \underline{x} , Λ ) \cdot exp [ {\sum }_{i = 1}^{F} {λ}_{i} {f}_{i} ( \underline{x} , y ) ] & EQ . 3 \\ Z ( \underline{x} , Λ ) = {\sum }_{y} exp [ {\sum }_{i = 1}^{F} {λ}_{i} {f}_{i} ( \underline{x} , y ) ] & EQ . 4\end{matrix}$$

where Λ={λ₁ . . . λ_{F}}εR^{F} is the set of real-valued model parameters. Thus, the Maximum Entropy model is calculated by taking the exponent of a weighted sum of indicator functions.

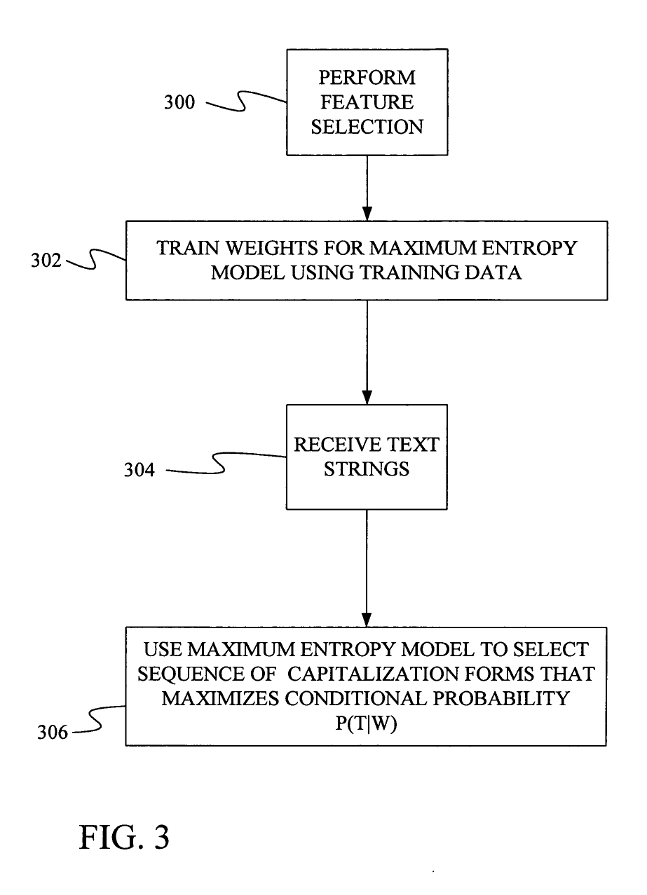

FIG. 3 provides a flow diagram of a method for training and using Maximum Entropy probabilities to identify capitalization for a string of text. In step 300, features are selected from a predefined set of features. This selection is performed using a simple count cutoff algorithm that counts the number of occurrences of each feature in a training corpus. Those features whose count is less than a pre-specified threshold are discarded. This reduces the number of parameters that must be trained. Optionally, it is possible to keep all features in the predefined set by setting the threshold to zero.

At step 302, the weights for the Maximum Entropy model are estimated. Under one embodiment, the model parameters Λ={λ₁ . . . λ_{F}}εR^{F} are estimated such that the model assigns maximum log-likelihood to a set of training data subject to a Gaussian prior centered at zero that ensures smoothing. In other embodiments, different prior distributions can be used for smoothing, such as an exponential prior. Under one embodiment that uses Improved Iterative Scaling to determine the model parameters, this results in an update equation for each Λ of: where λ satisfies:
λᵢ⁽ⁱ⁻¹⁾=λᵢ^{(t)}+δᵢ EQ. 6
where δᵢ satisfies:

$${\sum }_{\underline{x} , y} \tilde{p} ( \underline{x} , y ) {f}_{i} ( \underline{x} , y ) - \frac{{λ}_{i}}{{σ}_{i}^{2}} = \frac{{δ}_{i}}{{σ}_{i}^{2}} + {\sum }_{\underline{x} , y} \tilde{p} ( \underline{x} ) {p}_{Λ} ( y \vert \underline{x} ) {f}_{i} ( \underline{x} , y ) exp ( {δ}_{i} {f}^{\#} ( \underline{x} , y ) ) \qquad EQ . 6$$

where f^{#}(x,y) is the sum of the features that trigger for an event x,y. In Equation 6, \tilde{p}(x,y) is the relative frequency of the co-occurrence of context x and the output or tag y in the training data, \tilde{p}(x) is the relative frequency of the context in the training data and σᵢ² is the variance of the zero mean Gaussian prior.

Although the update equations are shown for the Improved Iterative Scaling estimation technique, other techniques may be used to estimate the model parameters by maximizing the log-likelihood such as Generalized Iterative Scaling, Fast Iterative Scaling, Gradient Ascent variants, or any other known estimation technique.

Once the weights of the Maximum Entropy model have been trained, strings of text that are to be capitalized are received at step 304. At step 306, the trained maximum entropy weights are used to find a sequence of capitalization forms for the sequence of words in a string of text that maximizes the conditional probability P(T|W). The sequence of capitalization that maximizes this probability is selected as the capitalization for the string of text.

The search for the sequence of tags that maximizes the conditional probability may be performed using any acceptable searching technique. For example, a Viterbi search may be performed by representing the possible capitalization forms for each word in a string as a trellis. At each word, a score is determined for each possible path into each capitalization form from the capitalization forms of the preceding word. When calculating these scores, the past capitalization forms used in the maximum entropy features are taken from the capitalization forms found along the path. The path that provides the highest score into a capitalization form is selected as the path for that capitalization form. The score for the path is then updated using the probability determined for that capitalization form of the current word. At the last word, the path with the highest score is selected, and the sequence of capitalization forms along that path is used as the capitalization forms for the sequence of words.

Although a Maximum Entropy model is used above, other models that use an exponential probability may be used to determine the conditional probability under other embodiments of the present invention. For example, Conditional Random Fields (CRF) may be used.

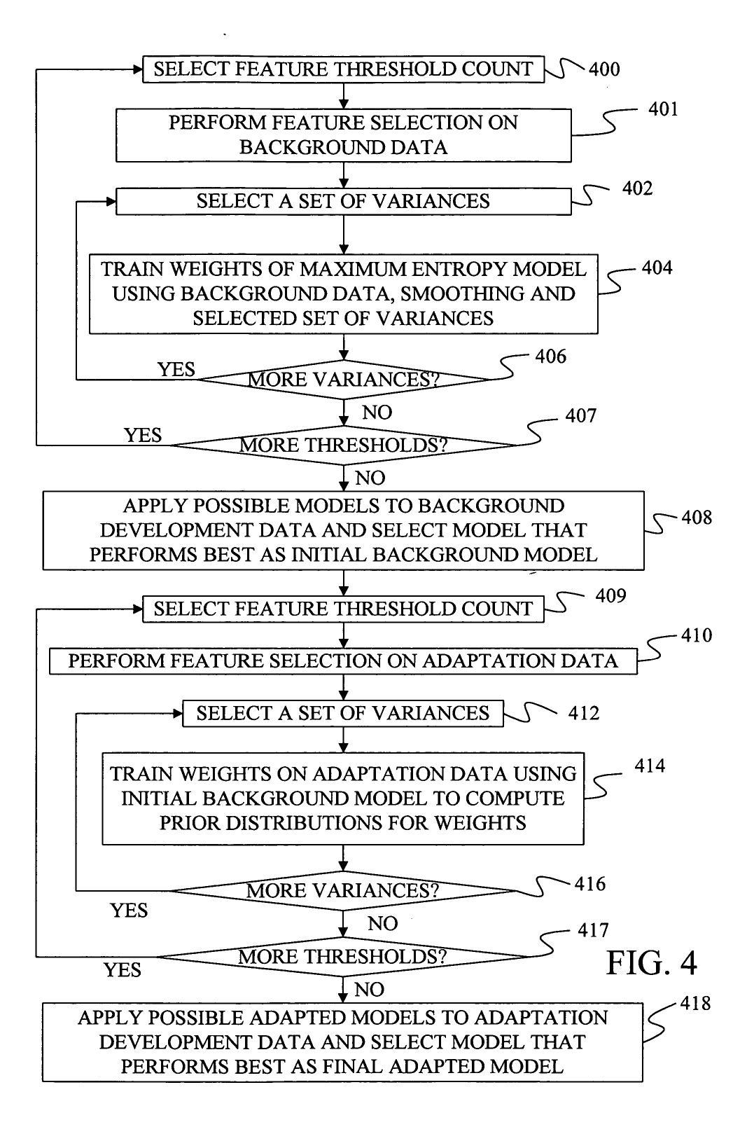

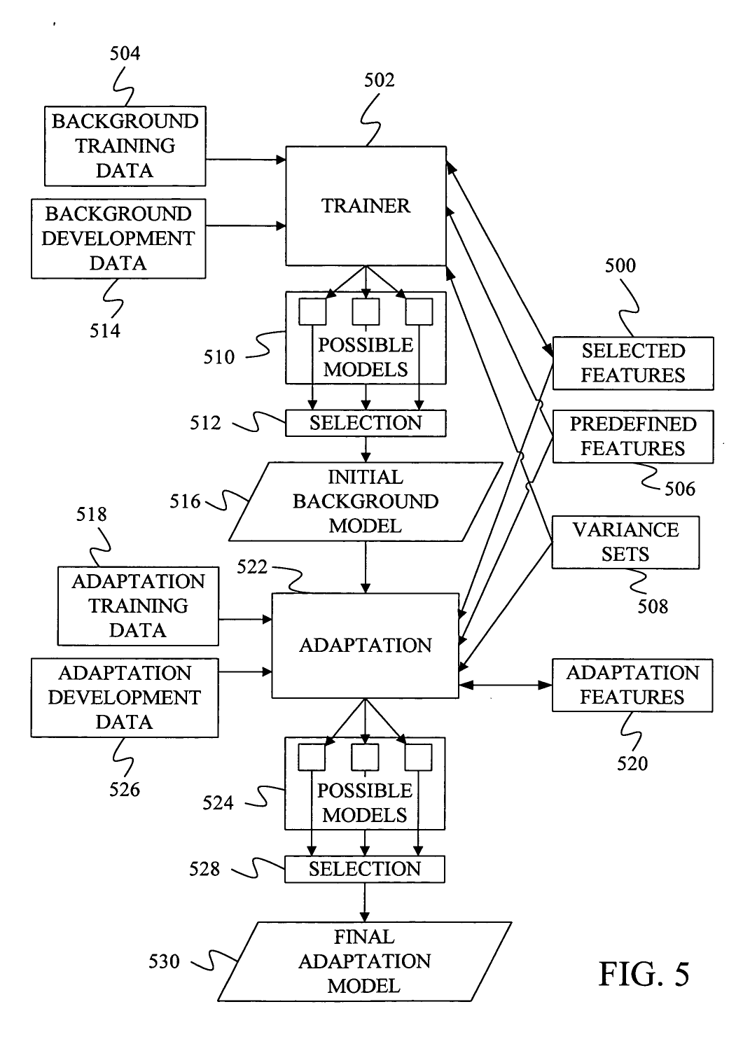

Under some embodiments of the present invention, a Maximum Entropy model is trained on a large set of background data and then adapted to a smaller set of specific data so that the model performs well with data of the type found in the smaller set of specific data. FIG. 4 provides a flow diagram of a method for adapting a Maximum Entropy model under the present invention and FIG. 5 provides a block diagram of elements used in adapting a Maximum Entropy model.

In step 400, a feature threshold count is selected. At step 401, this threshold count is used by a trainer 502 to select a set of features 500 based on the background training data 504. Under one embodiment, this involves counting the number of times each of a set of predefined features 506 occurs in background training data 504 and selecting only those features that occur more than the number of times represented by the threshold count.

At step 402, a variance for a prior Gaussian model is selected for each weight from a set of possible variances 508. At step 404, trainer 502 trains the weights of the maximum entropy model trained based on background training data 504 while using smoothing and the selected variances through Equations 5 and 6 identified above.

Note that in equations 5 and 6 above, an Improved Iterative Scaling technique was used to estimate the weights that maximize the log-likelihood. Step 404 is not limited to this estimation technique and other estimation techniques such as Generalized Iterative Scaling, Fast Iterative Scaling, Gradient Ascent, or any other estimation technique may be used to identify the weights.

At step 406, trainer 502 determines if there are more variances in the set of variances 508 that should be evaluated. Under the present invention, multiple sets of weights are trained using a different set of variances for each set of weights. If there are more sets of variances that need to be evaluated at step 406, the process returns to step 402 and a new set of variances is selected before a set of weights is trained for that set of variances at step 404. Steps 402, 404 and 406 are repeated until there are no more sets of variances to be evaluated.

When there are no further sets of variances to be evaluated at step 406, the process determines if there are more threshold counts to be evaluated at step 407. If there are more threshold counts, a new threshold count is selected at step 400 and steps 401, 402, 404, and 406 are repeated for the new threshold count. By using different threshold counts, different features sets are used to construct different maximum entropy models.

When there are no further threshold counts to be evaluated at step 407, a set of possible models 510 has been produced, each with its own set of weights. A selection unit 512 then selects the model that provides the best capitalization accuracy on background development data 514 at step 408. The selected model forms an initial background model 516.

At step 409, feature threshold count is again selected and at step 410, the feature selection process is repeated for a set of adaptation training data 518 to produce adaptation features 520. This can result in the same set, although generally it will produce a super-set of features from those selected at step 400.

At step 412, a set of variances for a prior model is once again selected from the collection of variances 508. Using the selected set of variances, adaptation training data 518, and the weights of initial background model 516, an adaptation unit 522 trains a set of adapted weights at step 414. Under one embodiment, a prior distribution for the weights is modeled as a Gaussian distribution such that the log-likelihood of the adaptation training data becomes:

$$L ( Λ ) = {\sum }_{\underline{x} , y} \tilde{p} ( \underline{x} , y ) log {p}_{Λ} ( y \vert \underline{x} ) - {\sum }_{i - 1}^{F} \frac{{( {λ}_{i} - {λ}_{i}^{0} )}^{2}}{2 {σ}_{i}^{2}} + const ( Λ ) \qquad EQ . 7$$

where the summation in the second term on the right hand side of Equation 7,

$$( {\sum }_{i - 1}^{F} \frac{{( {λ}_{i} - {λ}_{i}^{0} )}^{2}}{2 {σ}_{i}^{2}} ) ,$$

represents the probability of the weights given Gaussian priors for the weights that have means equal to the weights in initial background model 516 and variances that were selected in step 412. The summation of the second term is taken over all of the features formed from the union of selected features 500 formed through the feature selection process at step 400 and adaptation features 520 formed through the feature selection process at step 410. For features that were not present in the background data, the prior mean is set to zero. In other embodiments, steps 409 and 410 are not performed and the same features that are identified from the background data are used in Equation 7 for adapting the model.

Using this prior model and an Improved Iterative Scaling technique, the update equations for training the adapted weights at step 414 become:
λᵢⁱ⁺¹=λᵢ^{t}+δᵢ EQ. 8
where δᵢ satisfies:

$${\sum }_{\underline{x} , y} \tilde{p} ( \underline{x} , y ) {f}_{i} ( \underline{x} , y ) - \frac{( {λ}_{i} - {λ}_{i}^{0} )}{{σ}_{i}^{2}} = \frac{{δ}_{i}}{{σ}_{i}^{2}} + {\sum }_{\underline{x} , y} \tilde{p} ( \underline{x} ) {p}_{Λ} ( y \vert \underline{x} ) {f}_{i} ( \underline{x} , y ) exp ( {δ}_{i} {f}^{\#} ( \underline{x} , y ) ) \qquad EQ . 9$$

where \tilde{p}(x,y) is the relative frequency of the co-occurrence of context x and the output or tag y in adaptation training data 518 and \tilde{p}(x) is the relative frequency of the context in adaptation training data 518.

The effect of the prior probability is to keep the model parameters λᵢ close to the model parameters generated from the background data. The cost of moving away from the initial model parameters is specified by the magnitude of the variance δᵢ, such that a small variance will keep the model parameters close to the initial model parameters and a large variance will make the regularized log-likelihood insensitive to the initial model parameters, allowing the model parameters to better conform to the adaptation data.

In situations where a feature is not present in adaptation training data 518 but is present in background training data 504, the weight for the feature is still updated during step 414.

At step 416, the method determines if there are more sets of variances to be evaluated. If there are more sets of variances to be evaluated, the process returns to step 412 and a new set of variances is selected. Another set of weights is then adapted at step 414 using the new sets of variances and the weights of initial background model 516. Steps 412, 414, and 416 are repeated until there are no further variances to be evaluated.

When there are no further sets of variances to be evaluated at step 416, the process determines if there are further feature threshold counts to be evaluated at step 417. If there are further feature counts, a new feature count is selected at step 409 and steps 410, 412, 414 and 416 are repeated for the new threshold count.

Steps 412, 414, and 416 produce a set of possible adapted models 524. At step 418 the adapted model that provides the highest log-likelihood for a set of adaptation development data 526 using Equation 7, is selected by a selection unit 528 as the final adapted model 530.

Although in the description above, a Gaussian prior distribution was used in the log likelihood determinations of Equation 7, those skilled in the art will recognize that other forms of prior distributions may be used. In particular, an exponential prior probability may be used in place of the Gaussian prior.

Although the adaptation algorithm has been discussed above with reference to capitalization, it may be applied to any classification problem that utilizes a Maximum Entropy model, such as text classification for spam filtering and language modeling.

By allowing the model weights to be adapted to a small set of adaptation data, it is possible to train initial model parameters for the Maximum Entropy model and place those model parameters in a product that is shipped or transmitted to a customer. The customer can then adapt the Maximum Entropy model on specific data that is in the customer's system. For example, the customer may have examples of specific types of text such as scientific journal articles. Using these articles in the present adaptation algorithm, the customer is able to adapt the Maximum Entropy model parameters so they operate better with scientific journal articles.

Although the present invention has been described with reference to particular embodiments, workers skilled in the art will recognize that changes may be made in form and detail without departing from the spirit and scope of the invention.

What is claimed is:

1. A method of determining capitalization for text, the method comprising:
determining a probability of a capitalization form for a word using an exponentiated weighted sum of features that are based on the capitalization form and a context for the word; and
using the probability to select a capitalization form for the word.

2. The method of claim 1 wherein determining a probability comprises determining the probability using a maximum entropy model.

3. The method of claim 1 wherein determining a probability comprises determining the probability using a log-linear model.

4. The method of claim 1 wherein determining a probability comprises using an exponentiated weighted sum of features that is normalized such that it provides a proper probability assignment.

5. The method of claim 1 wherein determining a probability of a capitalization form for a word comprises determining the probability of a capitalization form for a current word in a sequence of words.

6. The method of claim 5 wherein the features comprise the identity of a previous word that occurs before the current word in the sequence of words.

7. The method of claim 5 wherein the features comprise the identity of a future word that occurs after the current word in the sequence of words.

8. The method of claim 5 wherein the features comprise the capitalization form for a previous word that occurs before the current word in the sequence of words.

9. The method of claim 5 wherein the features comprise the capitalization form for a second previous word that occurs two words before the current word in the sequence of words.

10. The method of claim 5 wherein the features comprise a portion of the word.

11. The method of claim 10 wherein the features comprise a prefix of the word.

12. The method of claim 10 wherein the features comprise a suffix of the word.

13. A computer-readable medium having computer-executable instructions for performing steps comprising:
determining a likelihood of a type of capitalization for a word by taking the exponent of a weighted sum of features; and
using the likelihood to identify a type of capitalization for the word.

14. The computer-readable medium of claim 13 wherein the features comprise the identity of the word.

15. The computer-readable medium of claim 13 wherein the features comprise the identity of a prior word that appears before the word in a sequence of words.

16. The computer-readable medium of claim 13 wherein the features comprise the identity of a next word that appears after the word in a sequence of words.

17. The computer-readable medium of claim 13 wherein the features comprise the type of capitalization applied to a prior word that appears before the word in a sequence of words.

18. The computer-readable medium of claim 13 wherein the features comprise the types of capitalization applied to two prior words that appear before the word in a sequence of words.

19. The computer-readable medium of claim 13 wherein the features comprise a prefix of the word.

20. The computer-readable medium of claim 13 wherein the features comprise a suffix of the word.

21. The computer-readable medium of claim 13 wherein determining a likelihood comprises determining a probability using a maximum entropy model.
